(19) United States
(12) Patent Application Publication
(10) Pub. No.: US 2010/0100402 A1
(43) Pub. Date: Apr. 22, 2010

(54) METHOD AND SYSTEM FOR DETERMINING AND SETTING ENVIRONMENTAL IMPACT RELATED PRICE POINTS

(76) Inventors: Rupesh Dilip Shah, Mountain View, CA (US); Benjamin Weiss, Portola Valley, CA (US); Todd M. Fitch, Santa Clara, CA (US); Barron R. Ernst, San Francisco, CA (US)

Correspondence Address: GUNNISON, MCKAY & HODGSON, L.L.P., 1900 GARDEN ROAD, SUITE 220, MONTEREY, CA, 93940, US

(21) Appl. No.: 12/253,650

(22) Filed: Oct. 17, 2008

(51) Int. Cl. G06Q 10/00; G06Q 30/00; G06Q 50/00

(52) U.S. Cl. 705/7; 705/400; 705/31; 705/412

(57) ABSTRACT

A system and method for price setting based on environmental impact whereby the environmental impact of a product and/or service is determined based on defined parameters. An environmental impact of a given product and/or service is also determined for various levels of consumption of the given product and/or service. An environmental impact goal is then established for the given product and/or service. An environmental impact goal level of consumption of the given product and/or service is then determined that will yield the desired environmental impact goal. An environmental impact goal price-point for the given product and/or service that will yield the environmental impact goal level of consumption that, in turn, will yield the desired environmental impact goal is then determined. The price of the given product or service is then set at the environmental impact goal price-point for the given product and/or service using one or more of various price setting mechanisms.

### BACKGROUND

Currently, there is increasing worldwide awareness that our planet is reaching the limit of its ability to withstand the environmental impact of human endeavors. As a result, more and more pressure is currently being placed on governments to quantify the environmental impact of various human activities and to mitigate the negative environmental impact of these human activities. In addition, many individuals are willing to take, and many are taking, whatever steps they can to make themselves aware of the environmental impact of their activities and to mitigate, or even eliminate, the negative environmental impact of these activities.

One area where most individuals, and governmental agencies, would like to have environmental impact information, and believe they can effect significant change, is in the area of consumer product and/or service purchases. That is to say, many people, and governmental agencies, would like to understand the environmental impact of the production of various consumer goods, and in many cases, individuals would be more than willing to modify their purchase behavior, and/or or accept regulation of purchases, based on the environmental impact of the product and/or service they are contemplating buying.

Indeed, many providers of products and/or services have recently recognized this public sentiment and have gone to great lengths, and expense, to emphasize to consumers any positive steps they have taken to minimize the environmental impact of the production of their goods and/or services.

However, despite the strong desire of both governmental agencies and individuals to quantify the environmental impact of various consumer products, and to mitigate the negative environmental impact of these products, currently there is little or no information available regarding the environmental impact of a given product and or service, and what little information is available is far from standardized, is by no means uniformly presented or accepted, and is often inconsistent or contradictory. Consequently, currently, both governmental agencies and individuals not only have no way to quantify the environmental impact of various products and/or services, but without this basic information, there is also no realistic way to mitigate the negative environmental impact of these products and/or services, i.e., how can you mitigate a negative impact you can't quantify or, in many cases, even recognize.

As a result of the situation described above, even though many people, and governmental agencies, want to understand the environmental impact of the production of various consumer goods they may purchase, and would be willing to modify their purchase behavior and/or or accept regulation of purchases, the required information and mitigation means are currently not readily available. Consequently, despite a willingness to change their behavior to help the environment, most people and governments are currently denied the necessary information and any mechanism to do so.

### SUMMARY

In accordance with one embodiment, a system and method for price setting based on environmental impact includes a process for price setting based on environmental impact whereby the environmental impact of a product and/or service is determined based on defined parameters. In one embodiment, an environmental impact of a given product and/or service is determined for various levels of consumption of the given product and/or service. In one embodiment, an environmental impact goal is then established for the given product and/or service. In one embodiment, an environmental impact goal level of consumption of the given product and/or service is determined that will yield the desired environmental impact goal. In one embodiment, an environmental impact goal price-point for the given product and/or service that will yield the environmental impact goal level of consumption that, in turn, will yield the desired environmental impact goal is determined. In one embodiment, the price of the given product or service is then set at the environmental impact goal price-point for the given product and/or service using one or more of various price setting mechanisms.

In one embodiment, the environmental impact of a product and/or service is determined based on defined parameters including, but not limited to: the average amount of fossil fuel used to produce, use, or dispose of, the product and/or service; the average carbon emissions associated with the production, use, or disposal, of the product and/or service; toxic, and/or otherwise undesirable, materials involved with the production, use, or disposal, of the product and/or service and/or that result from the production, use, or disposal, of the product and/or service; land use and/or land-fill issues associated with the production, use, or disposal, of the product and/or service; water use associated with the production, use, or disposal, of the product and/or service; any other resources used and/or associated with the production, use, or disposal, of the product and/or service; a country of origin of the product and/or service; and/or any other factor creating a negative environmental impact or involving a scarce/strategic commodity that is associated with the production, use, or disposal, of the product and/or service.

In one embodiment, the environmental impact of a given product and/or service is determined and/or stated by the provider of the given product and/or service and this data is then verified/audited by a regulatory agency such as, but not limited to: a governmental agency; a multi-national regulatory agency; a private environmental watch-dog agency; a private consumer watch-dog agency; or any other public and/or private authority charged with verifying stated environmental impact data. In one embodiment, the environmental impact of a given product and/or service is determined by any one of: a governmental agency; a multi-national regulatory agency; a private environmental watch-dog agency; a private consumer watch-dog agency; or any other public and/or private authority charged with calculating environmental impact data. In one embodiment, the environmental impact of a given product and/or service is expressed as a score and/or a level on an environmental impact scale.

In one embodiment, an environmental impact of a given product and/or service is determined for various levels of consumption of the given product and/or service to take into account economies of scale and/or any other factors that may not be determined by simply multiplying the average environmental impact of a single product and/or service by a number of units sold. In addition, secondary factors such as location of the production facilities, employment, and environmental activities and/or polices associated with the product and/or service provider can also be factored into the determination of the environmental impact of a given product and/or service for various levels of consumption of the given product and/or service. In one embodiment, the environmental impact of a given product and/or service at a given level of consumption is expressed as a score and/or a level on an environmental impact scale.

In one embodiment, an environmental impact goal is then established for the given product and/or service by any one of various means including, but not limited to: by federal, state, or local legislation; by federal, state, or local vote and/or proposition; by federal, state, or local administrative order; by multinational treaties and/or agreements; by the provider of the product and/or service; or by any other means and/or source of authority.

In one embodiment, the environmental impact of a given product and/or service determined for various levels of consumption of the given product and/or service is analyzed to determine an environmental impact goal level of consumption of the given product and/or service that will yield the desired environmental impact goal.

In one embodiment, an environmental impact goal price-point for the given product that will yield the environmental impact goal level of consumption that, in turn, will yield the desired environmental impact goal is determined using a supply and demand curve created based on sales data for the given product and/or service and the environmental impact of a given product and/or service data determined for various levels of consumption of the given product and/or service. In one embodiment, the sales data for the given product and/or service is determined, and/or provided by the provider of the product and/or service. In one embodiment, the sales data for the given product and/or service determined and/or provided by, the provider of the product and/or service is verified by, but not limited to, any one of the following: a governmental agency; a multi-national regulatory agency; a private environmental watch-dog agency; a private consumer watch-dog agency; an academic institution and/or agency; or any other public and/or private authority charged with verifying stated sales data for the given product and/or service. In one embodiment, the sales data for the given product and/or service is determined and/or provided by, but not limited to, any one of the following: a governmental agency; a multi-national regulatory agency; a private environmental watch-dog agency; a private consumer watch-dog agency; an academic institution and/or agency; or any other public and/or private authority charged with determining sales data for the given product and/or service.

In one embodiment, the price of the given product or service is then set at the environmental impact goal price-point for the given product and/or service using one or more of various price setting mechanisms including, but not limited to: federal, state and/or local sales taxes attached to the given product and/or service that raise the price of the given product and/or service to at least the environmental impact goal price-point for the given product and/or service; federal, local and/or state legislation requiring the given product and/or service be priced at least the environmental impact goal price-point for the given product and/or service by either the provider of the given product and/or service or any seller of the given product and/or service; and/or federal, local and/or state administrative decree requiring the given product and/or service be priced at least the environmental impact goal price-point for the given product and/or service by either the provider of the given product and/or service or any seller of the given product and/or service.

Using the process for price setting based on environmental impact, as disclosed herein, both governmental agencies and individuals are provided a systematic, uniform, and standardized system to quantify the environmental impact of various consumer products, a mechanism to make this information known, and a mechanism to mitigate the negative environmental impact of these products and/or services. Consequently, using the process for price setting based on environmental impact, as disclosed herein, governments and individuals are provided the information and mechanisms to change their behavior to help the environment and/or to conserve strategic resources.

### BRIEF DESCRIPTION OF THE DRAWINGS

FIG. 1 is a block diagram of an exemplary hardware architecture for implementing one embodiment;

FIG. 2 is a flow chart depicting a process for price setting based on environmental impact in accordance with one embodiment;

FIG. 3 is a supply and demand curve including a related environmental impact scale indicating an environmental impact of a given product and/or service for various levels of consumption of the given product and/or service; and

FIG. 4 is a supply and demand curve including a related environmental impact scale indicating an environmental impact of a given product and/or service for various levels of consumption of the given product and/or service and showing the predicted effect on the environmental impact of a given product and/or service for various levels of consumption of the given product and/or service related to a price set for the given product and/or service.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be embodied in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a system and method for price setting based on environmental impact includes a process for price setting based on environmental impact whereby the environmental impact of a product and/or service is determined based on defined parameters. In one embodiment, an environmental impact of a given product and/or service is determined for various levels of consumption of the given product and/or service. In one embodiment, an environmental impact goal is then established for the given product and/or service. In one embodiment, an environmental impact goal level of consumption of the given product and/or service is determined that will yield the desired environmental impact goal. In one embodiment, an environmental impact goal price-point for the given product and/or service that will yield the environmental impact goal level of consumption that, in turn, will yield the desired environmental impact goal is determined. In one embodiment, the price of the given product or service is then set at the environmental impact goal price-point for the given product and/or service using one or more of various price setting mechanisms.

### Hardware System Architecture

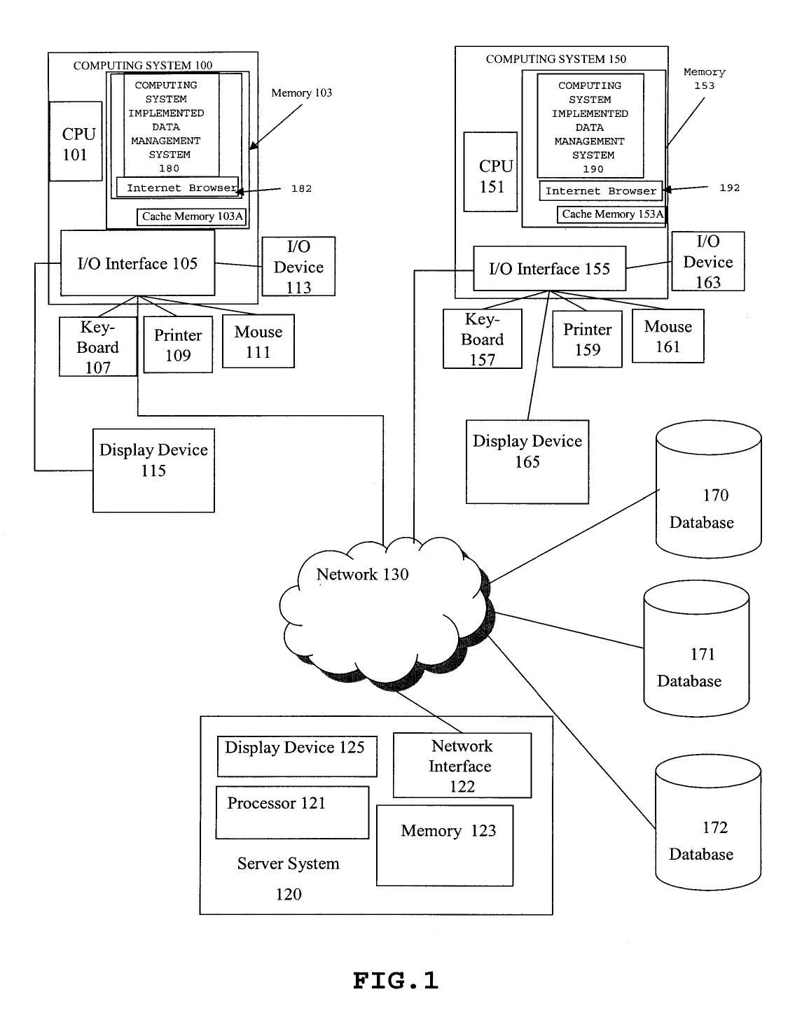

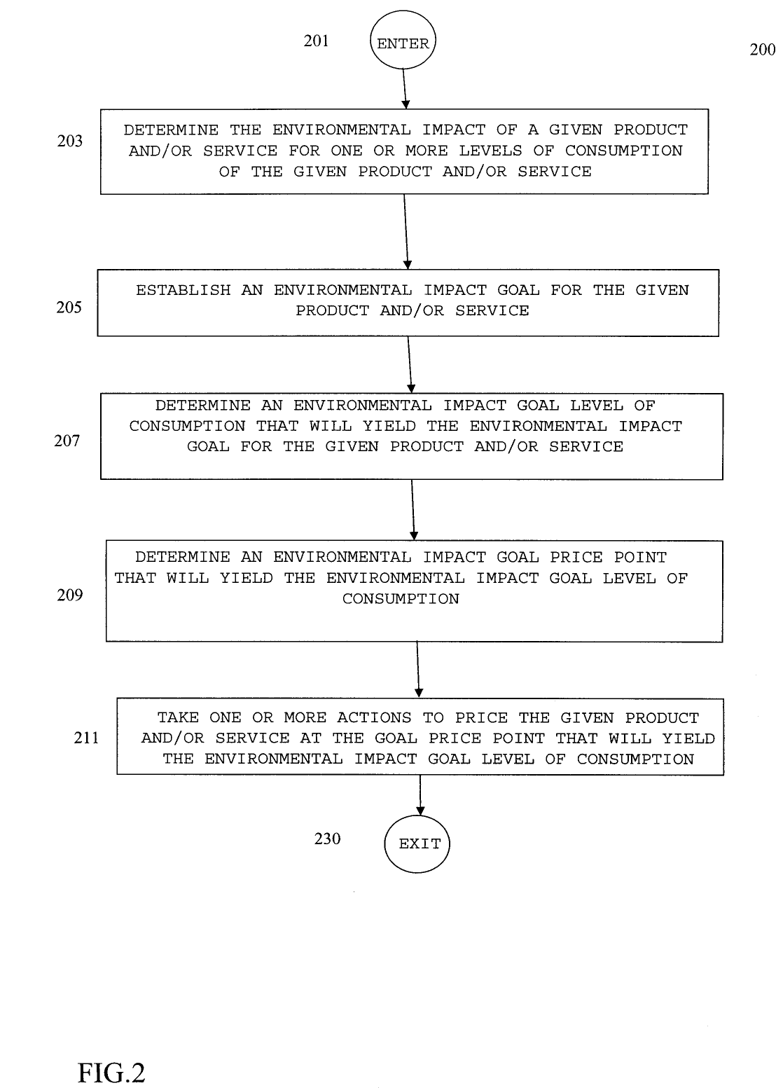

FIG. 1 is a block diagram of an exemplary hardware architecture for implementing one embodiment of a system and method for price setting based on environmental impact, such as exemplary process 200 (FIG. 2) discussed herein, that, returning to FIG. 1, includes: a computing system 100, e.g., a first computing system; a computing system 150, e.g., a second computing system; a server system 120; and exemplary databases 170, 171, and/or 172, all operatively coupled by a network 130.

As seen in FIG. 1, computing system 100 typically includes a central processing unit (CPU) 101, an input/output (I/O) interface 105, and a memory system 103, including cache memory 103A. In one embodiment, memory system 103 includes all, or part, of a computing system implemented data management system 180, such as any computing system implemented data management system discussed herein, and/or known in the art at the time of filing, and/or as developed thereafter. In one embodiment, computing system implemented data management system 180 is a computing system implemented business financial management system, as described herein, and/or known in the art at the time of filing, and/or as developed thereafter. In one embodiment, computing system implemented data management system 180 is stored, in whole, or in part, in memory system 103, and is used by, or includes, or is accessed by a process for price setting based on environmental impact.

Returning to FIG. 1, computing system 100 may further include standard user interface devices such as a keyboard 107, a mouse 111, a printer 109, and a display device 115, as well as, one or more standard input/output (I/O) devices 113, such as a compact disk (CD) or Digital Video Disc (DVD) drive, floppy disk drive, or other digital or waveform port, or other device capable of inputting data to, and outputting data from, computing system 100, whether available or known at the time of filing or as later developed. In one embodiment, a process for price setting based on environmental impact and/or a computing system implemented data management system are entered, in whole, or in part, into computing system 100 via I/O device 113, such as from a CD, DVD, floppy disk, portable hard drive, memory stick, download site, or other medium and/or computer program product as defined herein.

In one embodiment, computing system 100 also includes an Internet browser capability 182 that, in one embodiment, includes a search engine (not shown) and is stored, in whole, or in part in memory 103.

In one embodiment, computing system 100 is a computing system accessible by a process for price setting based on environmental impact. In one embodiment, computing system 100 is used, and/or accessible, by another computing system, such as computing system 150 (discussed below).

Computing system 100 can be any computing system as defined herein and/or as known in the art at the time of filing and/or as developed thereafter, that includes components that can execute all, or part, of a process for price setting based on environmental impact, and/or a computing system implemented data management system, in accordance with at least one of the embodiments as described herein.

Similarly, computing system 150 typically includes a CPU 151, an input/output (I/O) interface 155, and a memory system 153, including cache memory 153A. Similar to computing system 100, computing system 150 may further include standard user interface devices such as a keyboard 157, a mouse 161, a printer 159, and a display device 165, as well as, one or more standard input/output (I/O) devices 163, such as a compact disk (CD) or DVD drive, floppy disk drive, or other digital or waveform port, or other device capable of inputting data to, and outputting data from, computing system 150, whether available or known at the time of filing or as later developed.

In one embodiment, computing system 150 also includes an Internet browser capability 192 that, in one embodiment, includes a search engine (not shown) and is stored, in whole, or in part in memory 153.

In one embodiment, memory system 153 includes all, or part, of a computing system implemented data management system 190, such as any computing system implemented data management system defined herein, known in the art at the time of filing, and/or as developed thereafter. In one embodiment, computing system implemented data management system 190 is stored, in whole, or in part, in memory system 153, and is used by, or includes, or is accessed by, a process for price setting based on environmental impact.

In one embodiment, computing system 150 is a computing system accessible by a process for price setting based on environmental impact. In one embodiment, computing system 150 is used, and/or accessible, by another computing system, such as computing system 100.

Computing system 150 can be any computing system as defined herein and/or as known in the art at the time of filing and/or as developed thereafter, that includes components that can execute all, or part, of a process for price setting based on environmental impact, and/or a computing system implemented data management system, in accordance with at least one of the embodiments as described herein.

As discussed in more detail below, in one embodiment, all, or part, of a process for price setting based on environmental impact, and/or a computing system implemented data management system, and/or data representing sales and/or environmental impact data, can be loaded, in whole, or in part, into computing system 150 from computing system 100 for storage in memory system 153 and/or cache memory 153A.

Also shown in FIG. 1 are databases 170, 171, and/or 172. In one embodiment, one or more of databases 170, 171, and/or 172 is a data storage device, a designated server system or computing system, or a designated portion of one or more server systems or computing systems, such as computing systems 100, 150 and server system 120, or a distributed database, or an external and/or portable hard drive. In one embodiment, one or more of databases 170, 171, and/or 172 is a dedicated mass storage device implemented in software, hardware, or a combination of hardware and software. In one embodiment, one or more of databases 170, 171, and/or 172 include a web-based function. As discussed in more detail below, in one embodiment, one or more of databases 170, 171, and/or 172 is under the control of, includes, or is accessed by, a process for price setting based on environmental impact and data representing sales and/or environmental impact data is stored in one or more of databases 170, 171, and/or 172 as discussed in more detail below.

In one embodiment, all, or part, of a process for price setting based on environmental impact, and/or a computing system implemented data management system, and/or data representing sales and/or environmental impact data, is stored in one or more of databases 170, 171, and/or 172, and is used by, or is accessed by, a process for price setting based on environmental impact and/or a provider of and/or a computing system implemented data management system. In one embodiment, one or more of databases 170, 171, and/or 172 is used, and/or accessible, by a computing system, such as computing systems 100 and/or 150, and/or a server system, such as sever system 120 (discussed below). In one embodiment, one or more of databases 170, 171, and/or 172 is used, controlled, and/or accessible by, a provider of and/or a computing system implemented financial management system.

In one embodiment, computing systems 100 and 150, and databases 170, 171, and/or 172, are coupled to a server system 120 through network 130. In one embodiment, server system 120 includes a server system display device 125, a server system processor 121, a server system memory 123, and a server system network interface 122.

In one embodiment, server system 120 is used in a station-to-station arrangement, such as a peer-to-peer, or hybrid peer-to peer, arrangement, as an indexing and/or central server used to connect a first computing system, such as computing system 100, and a second computing system, such as computing system 150.

In one embodiment, all, or part, of a process for price setting based on environmental impact, and/or a computing system implemented data management system, and/or data representing sales and/or environmental impact data, is stored in server system 120, and is used by, or is accessed by, a process for price setting based on environmental impact. In one embodiment, server system 120 is used, and/or accessible, by a computing system, such as computing systems 100 and/or 150, and/or one or more databases, such as databases 170, 171, and/or 172.

Network 130 can be any network or network system as defined herein, and/or known in the art at the time of filing, and/or as developed after the time of filing, capable of allowing communication between two or more computing systems, server systems, and/or databases.

Those of skill in the art will readily recognize that the components shown in FIG. 1, such as computing systems 100 and 150, databases 170, 171, and/or 172, server system 120, and their respective components, are shown for illustrative purposes only and that architectures with more or fewer components can implement, and benefit from, the invention. Moreover, one or more components of computing system 100, computing system 150, databases 170, 171, and/or 172, and server system 120 may be located remotely from their respective system and accessed via network 130. In addition, the particular type of, and configuration of, computing systems 100 and 150, databases 170, 171, and/or 172, and server system 120 are not relevant.

As discussed in more detail below, in one embodiment, all, or part, of a process for price setting based on environmental impact, and/or a computing system implemented data management system, and/or data representing sales and/or environmental impact data, is stored in memory system 103 and/or cache memory 103A, of computing system 100, and/or memory system 153 and/or cache memory 153A of computing system 150, and/or in server memory system 123 of server system 120, and/or in databases 170, 171, and/or 172, and executed on computing system 100 and/or computing system 150. As used herein, a memory refers to a volatile memory, a non-volatile memory, or any combination of the two.

Although a process for price setting based on environmental impact, and/or a computing system implemented data management system, are sometimes referred to herein, alternatively, as a process, an application, a module, a program, a component of a software system, a component of a software package, a component of a parent system, a plug-in, or a feature of a parent system, this terminology is illustrative only. In some embodiments, a process for price setting based on environmental impact and/or a computing system implemented data management system are capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPUs 101 and 151, or server system processor 121. In one embodiment, execution of a process by CPU 101, CPU 151, or server system processor 121, results in the operations of an agent computer process (not shown) and/or a rule computer process (not shown).

In one embodiment, all, or part, of a process for price setting based on environmental impact, and/or a computing system implemented data management system, and/or data representing sales and/or environmental impact data, are computer applications or processes and/or data implemented and/or run and/or stored, in full, or in part, in, or on, and/or through, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as server system 120 of FIG. 1, and signals transmitted over a network, such as network 130 of FIG. 1, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

### Process

Herein, the terms “product”, “service”, and/or “product and/or service” are used interchangeably to denote any product and/or service that can be obtained by any party, by any means, as discussed herein, and/or known in the art at the time of filing, and/or as developed after the time of filing.

Herein, the terms “provider of a product”, “provider of a service”, and/or “provider of a product and/or service” are used interchangeably to denote any party that offers and/or provides any product and/or service that can be obtained by any party, by any means, as discussed herein, and/or known in the art at the time of filing, and/or as developed after the time of filing.

As used herein, the term “computing system”, denotes, but is not limited to: a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

As used herein, the term “computing system implemented data management system” includes, but is not limited to: computing system implemented personal and small business financial management systems, packages, programs, modules, or applications; computing system implemented business systems, packages, programs, modules, or applications; computing system implemented healthcare management systems, packages, programs, modules, or applications; computing system implemented payroll management systems, packages, programs, modules, or applications; computing system implemented marketing device distribution systems, packages, programs, modules, or applications; computing system implemented financial institution financial management systems, packages, programs, modules, or applications; computing system implemented tax preparation systems, packages, programs, modules, or applications; computing system implemented accounting and/or invoicing systems, packages, programs, modules, or applications; computing system implemented business and/or point of sale systems, packages, programs, modules, or applications; and various other electronic data driven data management systems, packages, programs, modules, or applications, whether known at the time of filling or as developed later.

As used herein, the term “network” is used to denote any network or network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, whether available or known at the time of filing or as later developed.

As used herein, the term “database” is used to define any data storage mechanism known at the time of filing or as developed thereafter, such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, and/or known at the time of filing, and/or as developed thereafter.

In accordance with one embodiment, a system and method for price setting based on environmental impact includes a process for price setting based on environmental impact whereby the environmental impact of a product and/or service is determined based on defined parameters. In one embodiment, an environmental impact of a given product and/or service is determined for various levels of consumption of the given product and/or service. In one embodiment, an environmental impact goal is then established for the given product and/or service. In one embodiment, an environmental impact goal level of consumption of the given product and/or service is determined that will yield the desired environmental impact goal. In one embodiment, an environmental impact goal price-point for the given product and/or service that will yield the environmental impact goal level of consumption that, in turn, will yield the desired environmental impact goal is determined. In one embodiment, the price of the given product or service is then set at the environmental impact goal price-point for the given product and/or service using one or more of various price setting mechanisms.

FIG. 2 a flow chart depicting a process for price setting based on environmental impact 200 in accordance with one embodiment. Process for price setting based on environmental impact 200 begins at ENTER OPERATION 201 of FIG. 2 and process flow proceeds to DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, the average amount of fossil fuel used to produce, use, or dispose of, the product and/or service. In one embodiment, the average amount of fossil fuel used to produce, use, or dispose of, the product and/or service is determined by any one of the following: a governmental agency; a multi-national regulatory agency; a private environmental watch-dog agency; a private consumer watch-dog agency; an academic institution and/or agency; or any other public and/or private authority capable of determining the average amount of fossil fuel used to produce, use, or dispose of, the product and/or service and empowered to do so.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, the average carbon emissions associated with the production, use, or disposal, of the product and/or service. In one embodiment, the average carbon emissions associated with the production, use, or disposal, of the product and/or service is determined by any one of the following: a governmental agency; a multi-national regulatory agency; a private environmental watch-dog agency; a private consumer watch-dog agency; an academic institution and/or agency; or any other public and/or private authority capable of determining the average carbon emissions associated with the production, use, or disposal, of the product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, the average gas or other airborne emissions associated with the production, use, or disposal, of the product and/or service. In one embodiment, the average gas or other airborne emissions associated with the production, use, or disposal, of the product and/or service is determined by any one of the following: a governmental agency; a multi-national regulatory agency; a private environmental watch-dog agency; a private consumer watch-dog agency; an academic institution and/or agency; or any other public and/or private authority capable of determining the average emissions associated with the production, use, or disposal, of the product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, toxic, and/or otherwise undesirable, materials involved with the production, use, or disposal, of the product and/or service and/or that result from the production, use, or disposal, of the product and/or service. In one embodiment, the toxic, and/or otherwise undesirable, materials involved with the production, or that result from the use or disposal, of the given product and/or service is determined by any one of the following: a governmental agency; a multi-national regulatory agency; a private environmental watch-dog agency; a private consumer watch-dog agency; an academic institution and/or agency; or any other public and/or private authority capable of determining the toxic, and/or otherwise undesirable, materials involved with the production, or that result from the use or disposal, of the given product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, land use and/or land-fill issues associated with the given product and/or service. In one embodiment, this factor can include the estimated time if takes products and/or by-products associated with the given product and/or service to degrade and how much space the products take up in a land-fill or similar disposal area. In one embodiment, this factor can include land used for facilities associated with the production, use, and/or disposal of the product and/or service. In one embodiment, the land use and/or land-fill issues associated with the given product and/or service are determined by any one of the following: a governmental agency; a multi-national regulatory agency; a private environmental watch-dog agency; a private consumer watch-dog agency; an academic institution and/or agency; or any other public and/or private authority capable of determining the land use and/or land-fill issues associated with the given product and/or service and empowered to do so.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, water use, erosion, and/or water contamination associated with the production, use, or disposal, of the product and/or service. In one embodiment, water use, erosion, and/or water contamination associated with the production, use, or disposal, of the product and/or service is determined by any one of the following: a governmental agency; a multi-national regulatory agency; a private environmental watch-dog agency; a private consumer watch-dog agency; an academic institution and/or agency; or any other public and/or private authority capable of determining water use, erosion, and/or water contamination associated with the production, use, or disposal, of the product and/or service and empowered to do so.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, any other resources used and/or associated with the production, use, or disposal, of the product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is determined based on defined parameters including, but not limited to, any combination of the above factors and/or any other factor creating a environmental impact or involving a scarce/strategic commodity that is associated with the production, use, or disposal, of the product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 any of the above factors, and/or the overall environmental impact of a given product and/or service, is determined and/or stated by the provider of the given product and/or service and this data is then verified/audited by a regulatory agency such as, but not limited to: a governmental agency; a multi-national regulatory agency; a private environmental watch-dog agency; a private consumer watch-dog agency; or any other public and/or private authority charged with verifying stated environmental impact data.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a product and/or service is express as a score and/or a ranking and/or a level on sliding scale.

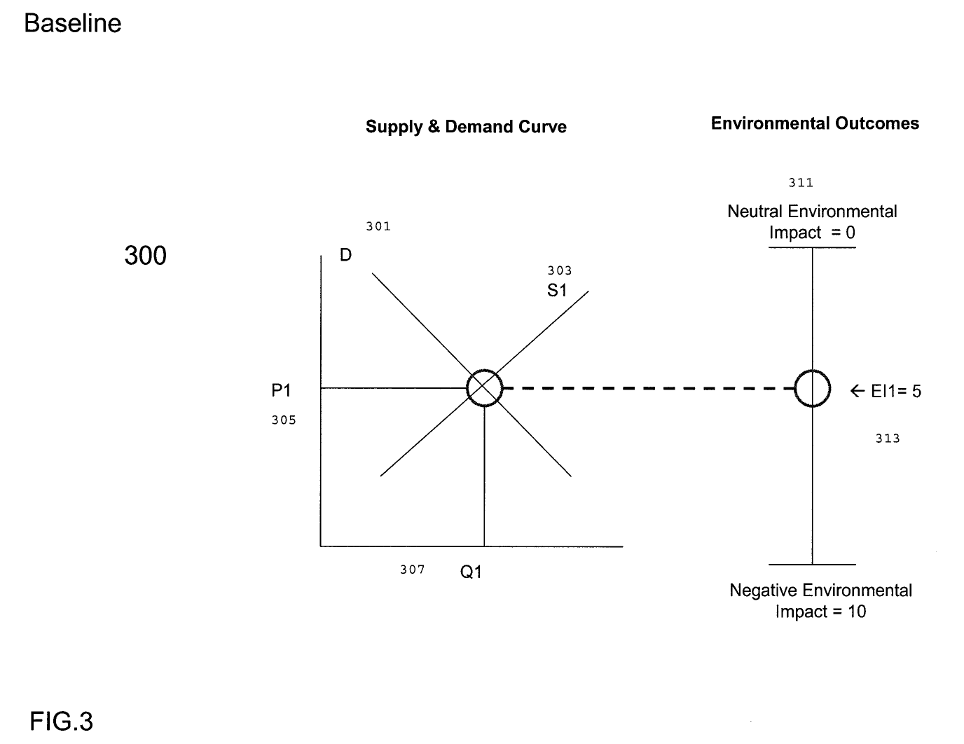

FIG. 3 shows supply and demand curves (discussed below) including a related environmental impact scale 311 indicating an environmental impact of a given product and/or service for various levels of consumption of the given product and/or service.

As can be seen in FIG. 3, environmental impact scale 311 is a sliding scale from a maximum negative environmental impact score, or level, of 10 to a neutral, or essentially non-existent, environmental impact score, or level, of 0. In the particular example of FIG. 3, the environmental impact of the given product and/or service is 5, EI1 (313). Various other elements of FIG. 3 are discussed in more detail below.

Returning to FIG. 2, in one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 an environmental impact of a given product and/or service is determined for various levels of consumption of the given product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 an environmental impact of a given product and/or service is determined for various levels of consumption of the given product and/or service to take into account economies, and/or environmental impacts, of scale and/or any other factors that may not be determined by simply multiplying the average environmental impact of a single product and/or service by a number of units sold.

In addition, in one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 secondary and/or migrating factors such as location of the production facilities, employment provided, tax revenues provided, and environmental activities and/or polices associated with the product and/or service provider can also be factored into the determination of the environmental impact of a given product and/or service for various levels of consumption of the given product and/or service.

In one embodiment, at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 the environmental impact of a given product and/or service at a given level of consumption is expressed as a score and/or a level on an environmental impact scale.

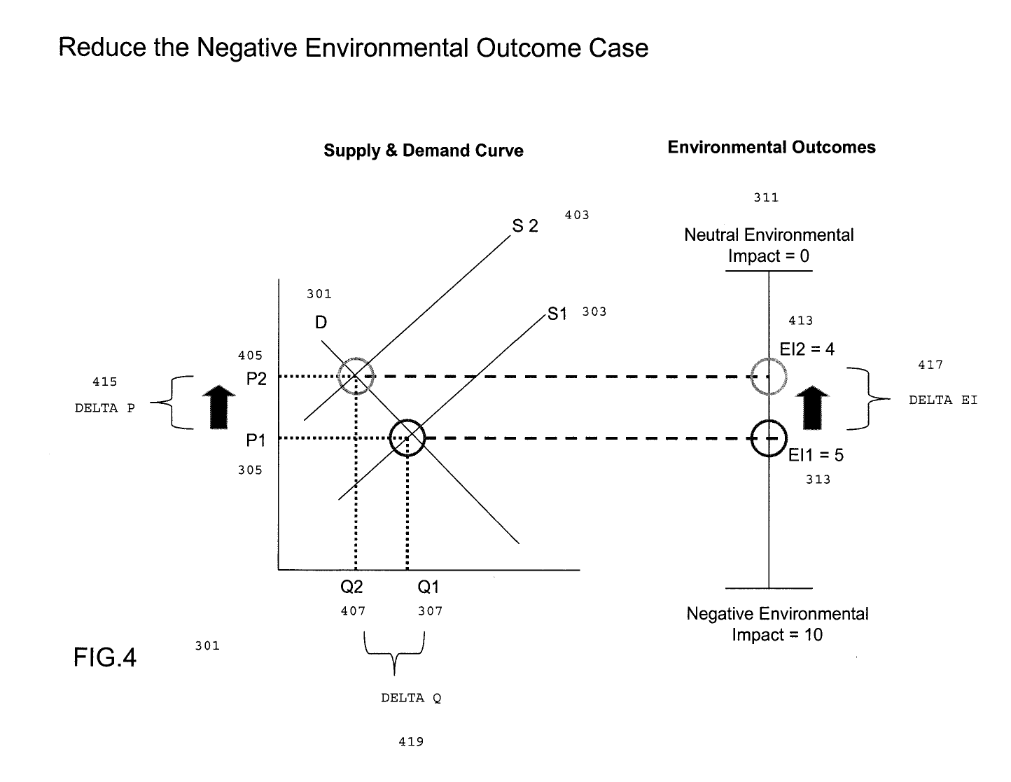

Returning to FIG. 3, environmental impact scale 311 is a sliding scale correlated to a given quantity, or level of consumption, Q1 (307) of the a product and/or service that is, in turn related to a given price P1 (305) for the a product and/or service. As discussed below with respect to FIG. 4, if the level of consumption Q1 (307) were to change from Q1 (307), the change would also effect the environmental impact score EI1 (313). For example, as shown in FIG. 4, if the level of consumption moves from Q1 (307) to Q2 (407), then the environmental impact score moves from EI1 (313) to EI2 (413). Various other elements of FIG. 4 are discussed in more detail below.

Returning to FIG. 2, in one embodiment, once the environmental impact of a product and/or service is determined based on defined parameters for given levels of consumption at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203, process flow proceeds to ESTABLISH AN ENVIRONMENTAL IMPACT GOAL FOR THE GIVEN PRODUCT AND/OR SERVICE OPERATION 205.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service by any one of various means including, but not limited to, by federal, state, or local legislation.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service by any one of various means including, but not limited to, by federal, state, or local voter degree and/or proposition.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service by any one of various means including, but not limited to, by federal, state, or local administrative order.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service by any one of various means including, but not limited to, by multinational treaties and/or agreements.

In one embodiment, at ESTABLISH AN ENVIRONMENTAL IMPACT GOAL FOR THE GIVEN PRODUCT AND/OR SERVICE OPERATION 205 an environmental impact goal is established for the given product and/or service by any one of various means including, but not limited to, by the provider of the product and/or service.

In some embodiments, at ESTABLISH AN ENVIRONMENTAL IMPACT GOAL FOR THE GIVEN PRODUCT AND/OR SERVICE OPERATION 205 an environmental impact goal is established for the given product and/or service by any combination of the above mechanisms and/or by any other means and/or source of authority.

In one embodiment, once an environmental impact goal is established for the given product and/or service at ESTABLISH AN ENVIRONMENTAL IMPACT GOAL FOR THE GIVEN PRODUCT AND/OR SERVICE OPERATION 205, process flow proceeds to DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207.

In one embodiment, at DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 an environmental impact goal level of consumption of the given product and/or service is determined that will yield the desired environmental impact goal of ESTABLISH AN ENVIRONMENTAL IMPACT GOAL FOR THE GIVEN PRODUCT AND/OR SERVICE OPERATION 205.

In one embodiment, at DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 the data representing the environmental impact of a given product and/or service determined for various levels of consumption of the given product and/or service of DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 is analyzed to determine an environmental impact goal level of consumption of the given product and/or service that will yield the desired environmental impact goal of ESTABLISH AN ENVIRONMENTAL IMPACT GOAL FOR THE GIVEN PRODUCT AND/OR SERVICE OPERATION 205.

Returning to FIG. 3, recall that FIG. 3 shows supply and demand curves 301 and 303 and a related environmental impact scale 311 indicating an environmental impact of a given product and/or service for various levels of consumption, such as Q1 (307), of the given product and/or service.

As can be seen in FIG. 3, environmental impact scale 311 is a sliding scale from a maximum negative environmental impact score, or level, of 10 to a neutral, or essentially non-existent, environmental impact score, or level, of 0. In the particular example of FIG. 3, the environmental impact of the given product and/or service being consumed at level Q1 (307) is EI1 of 5.

Using well known analysis of supply and demand curves, such as curves 301 and 303 of FIG. 3, as well as a related environmental impact scale 311 indicating an environmental impact EI1 (313) of a given product and/or service for various levels of consumption, such as Q1 (307) of the given product and/or service, the environmental impact of virtually any level of consumption can be determined. Consequently, returning to FIG. 2, in one embodiment, at DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 the desired environmental impact goal of ESTABLISH AN ENVIRONMENTAL IMPACT GOAL FOR THE GIVEN PRODUCT AND/OR SERVICE OPERATION 205 is found on related environmental impact scale 311 of FIG. 3 and then a corresponding level of consumption is indicated by the position on the quantity line that correlates to the intersection of the supply and demand curves 301 and 303.

Supply and demand curves are well known to those of skill in the art. Consequently, a more detailed discussion of supply and demand curve analysis is omitted here to avoid detracting from the invention.

In one embodiment, the data required to create supply and demand curves, such as 301 and 303 of FIG. 3, is obtained from the sales data for the given product and/or service as determined, and/or provided, by the provider of the product and/or service. In one embodiment, the sales data for the given product and/or service determined, and/or provided by, the provider of the product and/or service is verified by any one of the following: a governmental agency; a multi-national regulatory agency; a private environmental watch-dog agency; a private consumer watch-dog agency; an academic institution and/or agency; or any other public and/or private authority charged with verifying stated sales data for the given product and/or service.

In one embodiment, the data required to create supply and demand curves, such as 301 and 303 of FIG. 3, is obtained from the sales data for the given product and/or service as determined, and/or provided, by any one of the following: a governmental agency; a multi-national regulatory agency; a private environmental watch-dog agency; a private consumer watch-dog agency; an academic institution and/or agency; or any other public and/or private authority charged with determining sales data for the given product and/or service.

In one embodiment, once an environmental impact goal level of consumption of the given product and/or service is determined that will yield the desired environmental impact goal of ESTABLISH AN ENVIRONMENTAL IMPACT GOAL FOR THE GIVEN PRODUCT AND/OR SERVICE OPERATION 205 at DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207, process flow proceeds to DETERMINE AN ENVIRONMENTAL IMPACT GOAL PRICE POINT THAT WILL YIELD THE ENVIRONMENTAL IMPACT GOAL LEVEL OF CONSUMPTION OPERATION 209.

In one embodiment, at DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 an environmental impact goal price-point for the given product that will yield the environmental impact goal level of consumption of DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 that, in turn, will yield the desired environmental impact goal of ESTABLISH AN ENVIRONMENTAL IMPACT GOAL FOR THE GIVEN PRODUCT AND/OR SERVICE OPERATION 205 is determined.

In one embodiment, at DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 an environmental impact goal price-point for the given product that will yield the environmental impact goal level of consumption that, in turn, will yield the desired environmental impact goal is determined, in one embodiment as discussed above, using supply and demand curves created based on sales data for the given product and/or service and the environmental impact of a given product and/or service data determined for various levels of consumption of the given product and/or service.

As noted above, in one embodiment, the sales data for the given product and/or service is determined, and/or provided by the provider of the product and/or service. As also noted above, in one embodiment, the sales data for the given product and/or service determined and/or provided by, the provider of the product and/or service is verified by, but not limited to, any one of the following: a governmental agency; a multi-national regulatory agency; a private environmental watch-dog agency; a private consumer watch-dog agency; an academic institution and/or agency; or any other public and/or private authority charged with verifying stated sales data for the given product and/or service.

In one embodiment, the sales data for the given product and/or service is determined and/or provided by, but not limited to, any one of the following: a governmental agency; a multi-national regulatory agency; a private environmental watch-dog agency; a private consumer watch-dog agency; an academic institution and/or agency; or any other public and/or private authority charged with determining sales data for the given product and/or service.

FIG. 4 shows supply and demand curves 301, 303 and 403 including a related environmental impact scale 311 indicating an environmental impact EI1 (313) and EI2 (413) of a given product and/or service for two levels of consumption Q1 (307) and Q2 (309) of the given product and/or service related to two price points for the given product and/or service P1 (305) and P2 (405).

Referring to FIGS. 2 and 4 together, as a specific illustrative example, it is postulated that at DETERMINE THE ENVIRONMENTAL IMPACT OF A GIVEN PRODUCT AND/OR SERVICE FOR ONE OR MORE LEVELS OF CONSUMPTION OF THE GIVEN PRODUCT AND/OR SERVICE OPERATION 203 it is determined that for a given product and/or service, at price P1 (305) for the given product and/or service the level of consumption is Q1 (307) and that, in turn results in a negative environmental impact of EI1 (313) equal to 5 on related environmental impact scale 311.

Now assume at ESTABLISH AN ENVIRONMENTAL IMPACT GOAL FOR THE GIVEN PRODUCT AND/OR SERVICE OPERATION 205 it is determined that the environmental impact goal for the given product and/or service is established to be a maximum of 4 on related environmental impact scale 311, i.e., point EI2 (413) on related environmental impact scale 311. Then at DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 it is determined that the level of consumption must be moved from Q1 (307) to Q2 (407) to meet the environmental impact goal for the given product and/or service of ESTABLISH AN ENVIRONMENTAL IMPACT GOAL FOR THE GIVEN PRODUCT AND/OR SERVICE OPERATION 205.

It is then determined at DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 that to shift the level of consumption from Q1 (307) to Q2 (407) to meet the environmental impact goal for the given product and/or service of ESTABLISH AN ENVIRONMENTAL IMPACT GOAL FOR THE GIVEN PRODUCT AND/OR SERVICE OPERATION 205, the price of the product and/or service must be moved from P1 (305) to P2 (405). Therefore, P2 (405) is determined to be the environmental impact goal price-point.

In short, as can also be seen in FIG. 4, in this one example of one embodiment, at DETERMINE AN ENVIRONMENTAL IMPACT GOAL PRICE POINT THAT WILL YIELD THE ENVIRONMENTAL IMPACT GOAL LEVEL OF CONSUMPTION OPERATION 209, it is determined that moving the price of the product and/or service an amount DELTA P (415) from P1 (305) to P2 (405), with P2 (405) being the environmental impact goal price-point, results in moving the consumption of the product and/or service an amount DELTA Q from Q1 (307) to Q2 (407), with Q2 (407) being the environmental impact goal consumption level, and this, in turn, results in moving the environmental impact score for the product and/or service an amount DELTA EI (417) from EI1 (307) to EI2 (407), with EI2 (407) being the environmental impact goal.

In one embodiment, once an environmental impact goal price-point for the given product that will yield the environmental impact goal level of consumption of DETERMINE AN ENVIRONMENTAL IMPACT GOAL LEVEL OF CONSUMPTION THAT WILL YIELD THE ENVIRONMENTAL IMPACT GOAL FOR THE GIVEN PRODUCT AND/OR SERVICE OPERATION 207 that, in turn, will yield the desired environmental impact goal of ESTABLISH AN ENVIRONMENTAL IMPACT GOAL FOR THE GIVEN PRODUCT AND/OR SERVICE OPERATION 205 is determined at DETERMINE AN ENVIRONMENTAL IMPACT GOAL PRICE POINT THAT WILL YIELD THE ENVIRONMENTAL IMPACT GOAL LEVEL OF CONSUMPTION OPERATION 209, process flow proceeds to TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211.

In one embodiment, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using one or more of various price setting mechanisms.

In one embodiment, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using one or more of various price setting mechanisms including, but not limited to, federal, state and/or local sales or other taxes attached to the given product and/or service that raise the price of the given product and/or service to at least the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209.

In one embodiment, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using one or more of various price setting mechanisms including, but not limited to, imposing a federal, state and/or local tax on the provider of the given product and/or service that, in turn is passed along to the consumer and thereby raises the price of the given product and/or service to at least the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209.

In one embodiment, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using one or more of various price setting mechanisms including, but not limited to, federal, local and/or state legislation requiring the given product and/or service be priced at least the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 by either the provider of the given product and/or service or any seller of the given product and/or service.

In one embodiment, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using one or more of various price setting mechanisms including, but not limited to, federal, local and/or state administrative decree requiring the given product and/or service be priced at least the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 by either the provider of the given product and/or service or any seller of the given product and/or service.

In various embodiments, at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211 the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 using any combination of the above means and/or mechanisms of setting the price of the given product or service and/or any other means and/or mechanisms of setting the price of the given product or service, as discussed herein, and/or known in the art at the time of filing, and/or as developed thereafter.

In one embodiment, once the price of the given product or service is set at the environmental impact goal price-point for the given product and/or service of DETERMINE AN ENVIRONMENTAL IMPACT GOAL PRICE POINT THAT WILL YIELD THE ENVIRONMENTAL IMPACT GOAL LEVEL OF CONSUMPTION OPERATION 209 at TAKE ONE OR MORE ACTIONS TO PRICE THE GIVEN PRODUCT AND/OR SERVICE AT THE GOAL PRICE POINT THAT WILL YIELD THE ENVIRONMENTAL IMPACT GOAL LEVEL OF CONSUMPTION OPERATION 211, process flow proceeds to EXIT OPERATION 230. In one embodiment, at EXIT OPERATION 230, process for price setting based on environmental impact 200 is exited to await new data.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Using process for price setting based on environmental impact 200, both governmental agencies and individuals are provided a systematic, uniform, and standardized system to quantify the environmental impact of various consumer products, a mechanism to make this information known, and a mechanism to mitigate the negative environmental impact of these products and/or services. Consequently, using process for price setting based on environmental impact 200, governments and individuals are provided the information and mechanisms to change their behavior to help the environment and/or to conserve strategic resources

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “obtaining”, “establishing”, “identifying”, “providing”, “determining”, “storing”, etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus, means, or system for performing the operations described herein. This apparatus, means, or system may be specifically constructed for the required purposes, or the apparatus, means, or system can comprise a general purpose system selectively activated or configured/reconfigured by a computer program stored via a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of networks, are defined herein, operating over numerous topologies.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

In the discussion above, certain aspects of various embodiments include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Therefore, numerous variations, whether explicitly provided for by the specification or implied by the specification or not, may be implemented by one of skill in the art in view of this disclosure.

What is claimed is:

1. A computing system implemented process for price setting based on environmental impact comprising:
defining one or more environmental impact parameters;
determining the environmental impact of a given product or service based, at least in part, on one or more of the one or more environmental impact parameters;
establishing an environmental impact goal for the given product or service;
determining an environmental impact goal level of consumption that will yield the environmental impact goal for the given product or service;
determining an environmental impact goal price point for the for the given product or service that will yield the environmental impact goal level of consumption for the product or service that will then yield the environmental impact goal for the given product or service; and
taking one or more actions to establish the price for the given product or service at the environmental impact goal price point.

2. The computing system implemented process for price setting based on environmental impact of claim 1, wherein;
one or more of the one or more environmental impact parameters are chosen from the group of environmental impact parameters consisting of:
the amount of fossil fuel used to produce, use, or dispose of, the product or service;
the amount of carbon emissions associated with the production, use, or disposal, of the product or service;
the amount of toxic, and/or otherwise undesirable, materials involved with the production, use, or disposal, of the product and/or service;
land use issues associated with the production, use, or disposal, of the product or service;
water use associated with the production, use, or disposal, of the product or service;
water contamination associated with the production, use, or disposal, of the product or service;
scarce resources used and/or associated with the production, use, or disposal, of the product or service;
a country of origin of the product or service; and
strategic resources used and/or associated with the production, use, or disposal, of the product or service.

3. The computing system implemented process for price setting based on environmental impact of claim 1, wherein;
the environmental impact of a given product or service is determined based, at least in part, on one or more of the one or more environmental impact parameters by one or more parties chosen from the group of parties consisting of:
a provider of the given product or service;
a governmental agency;
a multi-national regulatory agency;
a private environmental watch-dog agency;
a private consumer watch-dog agency; and
an academic institution and/or agency.

4. The computing system implemented process for price setting based on environmental impact of claim 1, wherein;
determining the environmental impact of a given product or service based, at least in part, on one or more of the one or more environmental impact parameters comprises determining the environmental impact of a given product or service based, at least in part, on one or more of the one or more environmental impact parameters for two or more levels of consumption of the given product or service.

5. The computing system implemented process for price setting based on environmental impact of claim 1, wherein;
the environmental impact goal for the given product or service is established by a governing authority.

6. The computing system implemented process for price setting based on environmental impact of claim 1, wherein;
the environmental impact goal for the given product or service is established by one or more sources of authority selected from the group of authorities consisting of:
a governmental agency;
a multi-state agreement;
a multi-national treaty;
a multi-national regulatory agency;
a private environmental watch-dog agency;
a private consumer watch-dog agency; and
an academic institution and/or agency.

7. The computing system implemented process for price setting based on environmental impact of claim 1, wherein;
an environmental impact goal level of consumption that will yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

8. The computing system implemented process for price setting based on environmental impact of claim 1, wherein;
an environmental impact goal price point for the given product or service that will yield the environmental impact goal level of consumption for the product or service that will then yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

9. The computing system implemented process for price setting based on environmental impact of claim 1, wherein;
taking one or more actions to establish the price for the given product or service at the environmental impact goal price point comprises taking one or more actions selected from the group of actions consisting of:
imposing federal, state and/or local sales taxes on the given product or service that raise the price of the given product or service to at least the environmental impact goal price-point for the given product or service;
imposing federal, state and/or local sales taxes on the given product or service provider;
passing federal, local and/or state legislation requiring the given product or service be priced at least at the environmental impact goal price-point for the given product or service by the provider of the given product or service;
passing federal, local and/or state legislation requiring the given product or service be priced at least at the environmental impact goal price-point for the given product or service by any seller of the given product or service;
issuing federal, local and/or state administrative decree requiring the given product or service be priced at least at the environmental impact goal price-point for the given product or service by the provider of the given product or service; and
issuing federal, local and/or state administrative decree requiring the given product or service be priced at least at the environmental impact goal price-point for the given product or service by any seller of the given product and/or service.

10. A computer program product for providing a process for price setting based on environmental impact comprising:
a computer readable medium;
and computer program code, encoded on the computer readable medium, comprising computer readable instructions for:
defining one or more environmental impact parameters;
determining the environmental impact of a given product or service based, at least in part, on one or more of the one or more environmental impact parameters;
establishing an environmental impact goal for the given product or service;
determining an environmental impact goal level of consumption that will yield the environmental impact goal for the given product or service;
determining an environmental impact goal price point for the for the given product or service that will yield the environmental impact goal level of consumption for the product or service that will then yield the environmental impact goal for the given product or service; and
taking one or more actions to establish the price for the given product or service at the environmental impact goal price point.

11. The computer program product for providing a process for price setting based on environmental impact of claim 10, wherein;
one or more of the one or more environmental impact parameters are chosen from the group of environmental impact parameters consisting of:
the amount of fossil fuel used to produce, use, or dispose of, the product or service;
the amount of carbon emissions associated with the production, use, or disposal, of the product or service;
the amount of toxic, and/or otherwise undesirable, materials involved with the production, use, or disposal, of the product and/or service;
land use issues associated with the production, use, or disposal, of the product or service;
water use associated with the production, use, or disposal, of the product or service;
water contamination associated with the production, use, or disposal, of the product or service;
scarce resources used and/or associated with the production, use, or disposal, of the product or service;
a country of origin of the product or service; and
strategic resources used and/or associated with the production, use, or disposal, of the product or service.

12. The computer program product for providing a process for price setting based on environmental impact of claim 10, wherein;
the environmental impact of a given product or service is determined based, at least in part, on one or more of the one or more environmental impact parameters by one or more parties chosen from the group of parties consisting of:
a provider of the given product or service;
a governmental agency;
a multi-national regulatory agency;
a private environmental watch-dog agency;
a private consumer watch-dog agency; and
an academic institution and/or agency.

13. The computer program product for providing a process for price setting based on environmental impact of claim 10, wherein;
determining the environmental impact of a given product or service based, at least in part, on one or more of the one or more environmental impact parameters comprises determining the environmental impact of a given product or service based, at least in part, on one or more of the one or more environmental impact parameters for two or more levels of consumption of the given product or service.

14. The computer program product for providing a process for price setting based on environmental impact of claim 10, wherein;
the environmental impact goal for the given product or service is established by a governing authority.

15. The computer program product for providing a process for price setting based on environmental impact of claim 10, wherein;
the environmental impact goal for the given product or service is established by one or more sources of authority selected from the group of authorities consisting of:
a governmental agency;
a multi-state agreement;
a multi-national treaty;
a multi-national regulatory agency;
a private environmental watch-dog agency;
a private consumer watch-dog agency; and
an academic institution and/or agency.

16. The computer program product for providing a process for price setting based on environmental impact of claim 10, wherein;
an environmental impact goal level of consumption that will yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

17. The computer program product for providing a process for price setting based on environmental impact of claim 10, wherein;
an environmental impact goal price point for the given product or service that will yield the environmental impact goal level of consumption for the product or service that will then yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

18. The computer program product for providing a process for price setting based on environmental impact of claim 10, wherein;
taking one or more actions to establish the price for the given product or service at the environmental impact goal price point comprises taking one or more actions selected from the group of actions consisting of:
imposing federal, state and/or local sales taxes on the given product or service that raise the price of the given product or service to at least the environmental impact goal price-point for the given product or service;
imposing federal, state and/or local sales taxes on the given product or service provider;
passing federal, local and/or state legislation requiring the given product or service be priced at least at the environmental impact goal price-point for the given product or service by the provider of the given product or service;
passing federal, local and/or state legislation requiring the given product or service be priced at least at the environmental impact goal price-point for the given product or service by any seller of the given product or service;
issuing federal, local and/or state administrative decree requiring the given product or service be priced at least at the environmental impact goal price-point for the given product or service by the provider of the given product or service; and
issuing federal, local and/or state administrative decree requiring the given product or service be priced at least at the environmental impact goal price-point for the given product or service by any seller of the given product and/or service.

19. A method for price setting based on environmental impact comprising:
defining one or more environmental impact parameters;
determining the environmental impact of a given product or service based, at least in part, on one or more of the one or more environmental impact parameters;
establishing an environmental impact goal for the given product or service;
determining an environmental impact goal level of consumption that will yield the environmental impact goal for the given product or service;
determining an environmental impact goal price point for the for the given product or service that will yield the environmental impact goal level of consumption for the product or service that will then yield the environmental impact goal for the given product or service; and
taking one or more actions to establish the price for the given product or service at the environmental impact goal price point.

20. The method for price setting based on environmental impact of claim 19, wherein;
one or more of the one or more environmental impact parameters are chosen from the group of environmental impact parameters consisting of:
the amount of fossil fuel used to produce, use, or dispose of, the product or service;
the amount of carbon emissions associated with the production, use, or disposal, of the product or service;
the amount of toxic, and/or otherwise undesirable, materials involved with the production, use, or disposal, of the product and/or service;
land use issues associated with the production, use, or disposal, of the product or service;
water use associated with the production, use, or disposal, of the product or service;
water contamination associated with the production, use, or disposal, of the product or service;
scarce resources used and/or associated with the production, use, or disposal, of the product or service;
a country of origin of the product or service; and
strategic resources used and/or associated with the production, use, or disposal, of the product or service.

21. The method for price setting based on environmental impact of claim 19, wherein;
the environmental impact of a given product or service is determined based, at least in part, on one or more of the one or more environmental impact parameters by one or more parties chosen from the group of parties consisting of:
a provider of the given product or service;
a governmental agency;
a multi-national regulatory agency;
a private environmental watch-dog agency;
a private consumer watch-dog agency; and
an academic institution and/or agency.

22. The method for price setting based on environmental impact of claim 19, wherein;
determining the environmental impact of a given product or service based, at least in part, on one or more of the one or more environmental impact parameters comprises determining the environmental impact of a given product or service based, at least in part, on one or more of the one or more environmental impact parameters for two or more levels of consumption of the given product or service.

23. The method for price setting based on environmental impact of claim 19, wherein;
the environmental impact goal for the given product or service is established by a governing authority.

24. The method for price setting based on environmental impact of claim 19, wherein;
the environmental impact goal for the given product or service is established by one or more sources of authority selected from the group of authorities consisting of:
a governmental agency;
a multi-state agreement;
a multi-national treaty;
a multi-national regulatory agency;
a private environmental watch-dog agency;
a private consumer watch-dog agency; and
an academic institution and/or agency.

25. The method for price setting based on environmental impact of claim 19, wherein;
an environmental impact goal level of consumption that will yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

26. The method for price setting based on environmental impact of claim 19, wherein;
an environmental impact goal price point for the given product or service that will yield the environmental impact goal level of consumption for the product or service that will then yield the environmental impact goal for the given product or service is determined based on data provided by one or more data sources selected from the group of data sources consisting of:
a provider of the given product or service;
a governmental agency;
a multi-national regulatory agency;
a private environmental watch-dog agency;
a private consumer watch-dog agency; and
an academic institution and/or agency.

27. The method for price setting based on environmental impact of claim 19, wherein;
taking one or more actions to establish the price for the given product or service at the environmental impact goal price point comprises taking one or more actions selected from the group of actions consisting of:
imposing federal, state and/or local sales taxes on the given product or service that raise the price of the given product or service to at least the environmental impact goal price-point for the given product or service;
imposing federal, state and/or local sales taxes on the given product or service provider;
passing federal, local and/or state legislation requiring the given product or service be priced at least at the environmental impact goal price-point for the given product or service by the provider of the given product or service;
passing federal, local and/or state legislation requiring the given product or service be priced at least at the environmental impact goal price-point for the given product or service by any seller of the given product or service;
issuing federal, local and/or state administrative decree requiring the given product or service be priced at least at the environmental impact goal price-point for the given product or service by the provider of the given product or service; and
issuing federal, local and/or state administrative decree requiring the given product or service be priced at least at the environmental impact goal price-point for the given product or service by any seller of the given product and/or service.
